(19) United States
(12) Patent Application Publication
(10) Pub. No.: US 2025/0172189 A1
(43) Pub. Date: May 29, 2025

(54) VIBRATION DAMPER FOR A MOTOR VEHICLE

(71) Applicants: thyssenkrupp Bilstein GmbH, Ennepetal (DE); thyssenkrupp AG, Essen (DE)

(72) Inventor: Lars SCHWEDLER, Arnsberg (DE)

(73) Assignees: thyssenkrupp Bilstein GmbH, Ennepetal (DE); thyssenkrupp AG, Essen (DE)

(21) Appl. No.: 18/953,636

(22) Filed: Nov. 20, 2024

(30) Foreign Application Priority Data
Nov. 23, 2023 (DE) 10 2023 132 745.3

(51) Int. Cl. F16F 9/49; F16F 9/36

(52) U.S. Cl. CPC F16F 9/49; F16F 9/368; F16F 2222/12; F16F 2230/0029; F16F 2230/007

(57) ABSTRACT

A vibration damper for a vehicle comprises a damper tube filled with hydraulic fluid, a working piston which is connected to a piston rod and which is arranged within the damper tube so as to be movable back and forth, wherein an interior of the damper tube is divided by the working piston into a first working chamber and a second working chamber, a rebound stop arrangement having an auxiliary piston, which concentrically surrounds the piston rod, and a sleeve-like rebound stop receptacle, which is mounted on the damper tube, for receiving the auxiliary piston in the rebound stage, wherein the auxiliary piston is mounted on the piston rod so as to be axially movable relative thereto, and the rebound stop arrangement has a spring element that is fastened to the auxiliary piston.

### CROSS REFERENCE TO RELATED APPLICATION

This application is a U.S. Non-Provisional that claims priority to German Patent Application No. DE 10 2023 132 745.3, filed Nov. 23, 2023, the entire content of which is incorporated herein by reference.

### FIELD

The present disclosure relates to a vibration damper for a motor vehicle having a rebound stop arrangement.

### BACKGROUND

DE 101 05 101 C1 has disclosed a hydraulic vibration damper having a hydraulic rebound stop. A hydraulic rebound stop commonly serves to provide additional damping in the end region of the rebound stage of the vibration damper. For this purpose, in known vibration dampers, an auxiliary piston plunges into a rebound stop chamber, and thus generates additional damping, as the piston rod moves in the rebound direction. The components that interact for the purposes of providing rebound damping commonly have to adhere to very precise manufacturing tolerances, for example in order to compensate for transverse forces on the piston rod. Said components are therefore commonly very expensive to manufacture.

Thus a need exists to provide a vibration damper having a rebound stop arrangement, wherein it is sought to achieve reliable damping by means of the rebound stop arrangement, and the rebound stop arrangement should be inexpensive to manufacture.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic illustration of a vibration damper according to one exemplary embodiment in a longitudinal sectional view.

FIG. 2 is a schematic illustration of a detail of a vibration damper according to a further exemplary embodiment in a longitudinal sectional view.

FIG. 3 is a schematic illustration of a detail of a vibration damper according to a further exemplary embodiment in a longitudinal sectional view.

### DETAILED DESCRIPTION

According to a first aspect, a vibration damper for a vehicle comprises a damper tube filled with hydraulic fluid, and a working piston which is connected to the piston rod and which is arranged within the damper tube so as to be movable back and forth, wherein the interior of the damper tube is divided by the working piston into a first, piston-rod-side working chamber and a second working chamber remote from the piston rod. In particular, the vibration damper also comprises a closure assembly which fluid-tightly closes off the damper tube at the piston rod side. The vibration damper furthermore comprises a rebound stop arrangement having an auxiliary piston, which concentrically surrounds the piston rod, and having an in particular sleeve-like rebound stop receptacle, which is mounted on the damper tube, for receiving the auxiliary piston in the rebound stage. The auxiliary piston is mounted on the piston rod so as to be axially movable relative thereto. The rebound stop arrangement has a spring element that is fastened to the auxiliary piston. The spring element is preferably positioned mechanically in series with the auxiliary piston.

The axial mobility of the auxiliary piston relative to the piston rod gives rise to mechanical decoupling of the two elements from one another. An additional fastening of the spring element to the auxiliary piston ensures that the spring element is positioned mechanically in series with the auxiliary piston. As the piston rod moves in the rebound direction, the auxiliary piston is moved in the rebound direction and, together with the spring element positioned in series therewith, provides damping of the piston movement in the rebound direction. The auxiliary piston provides damping of the piston rod movement in particular when said auxiliary piston moves into the rebound stop receptacle. The spring element that is additionally positioned in series allows the use of a rebound stop receptacle of relatively short length, because even a relatively short damping travel of the auxiliary piston is sufficient. A cost reduction and a simplification of the assembly process are thus achieved. Additionally, in particular owing to the positioning in series, a smoother response behaviour of the hydraulic rebound stop is achieved. In particular, the positioning of the spring element and the auxiliary piston in series results in progressive damping, where the damping force of the rebound stop increases with increasing piston speed.

The spring element preferably serves for additionally damping the movement of the piston rod in the rebound direction. In particular, the spring element is mounted so as to be movable in the axial direction relative to, and along, the piston rod. A fastening of the spring element to the auxiliary piston also has the effect that the spring element is guided in the axial direction and that the spring element is additionally centered on the piston rod.

The vibration damper is for example a single-tube or a multi-tube vibration damper. For example, a multi-tube vibration damper for a vehicle comprises an outer tube and an inner tube arranged coaxially with respect to said outer tube, wherein, between the outer tube and the inner tube, there is formed an equalizing chamber for receiving hydraulic fluid, and a working piston which is connected to the piston rod and which is arranged within the inner tube so as to be movable back and forth, wherein the interior of the inner tube is divided by the working piston into a first working chamber and a second working chamber. The equalizing chamber is preferably at least partially filled with a gas, in particular at the upper end. The outer tube preferably at least partially forms the housing of the vibration damper. The inner surface of the inner tube is preferably formed as a guide for the working piston. The working piston preferably has a valve device by means of which the first and the second working chamber are connected to one another. In particular, the inner tube has at least one passage opening which fluidically connects the first, piston-rod-side working chamber to the annular chamber, wherein the passage opening is formed in the first working chamber. In the case of a single-tube vibration damper, it is preferably the case that no outer tube is provided. The inner tube is preferably referred to as a damper tube, and receives the piston rod and the working piston as described above with regard to the inner tube.

In the case of a multi-tube vibration damper, the vibration damper has, in particular, a closure assembly that is designed and arranged to fluidically seal off the interior of the outer tube at the piston rod side. The piston-rod-side end of the inner tube is preferably fastened to the closure assembly. Opposite the closure assembly, at the end remote from the piston rod, the interior of the outer tube is preferably fluidically sealed off by means of a base piece. In particular, a base valve is arranged on the base piece, which base valve is mounted in particular on that end of the inner tube which is remote from the piston rod. The second working chamber is preferably fluidically connected via the base valve to the equalizing chamber. The base valve is preferably a check valve through which flow can pass in both directions or only in one direction. For example, the base valve is designed as a check valve in the rebound direction, in the case of a piston movement in a direction out of the inner tube, and is designed as a characteristic-defining valve in the bump direction, in the case of a piston movement into the inner tube.

In the case of a single-tube vibration damper, the vibration damper has, in particular, a closure assembly that is designed and arranged to fluidically seal off the interior of the damper tube at the piston rod side. The piston-rod-side end of the damper tube is preferably fastened to the closure assembly. Opposite the closure assembly, at the end remote from the piston rod, the interior of the damper tube is preferably fluidically sealed off by means of an axially movable sealing element. The sealing element preferably separates a gas space, which is adjacent thereto in the axial direction, from the working chamber that is filled with hydraulic fluid. For example, the vibration damper does not have a base valve but merely has a base piece, wherein the base piece forms a fluid-tight closure of the damper tube, and an adjustment valve is provided which is external with respect to the damper tube and which generates the damping action for example in the bump direction. It is also conceivable, in particular in the case of a single-tube vibration damper, to replace the base piece with a separating piston that separates the working chamber remote from the piston rod from a gas space.

In the description that follows, the term “vibration damper” is to be understood to mean both a multi-tube vibration damper and a single-tube vibration damper, wherein the damper tube is the inner tube of a multi-tube vibration damper. Below, a movement in the rebound direction is to be understood to mean a movement in the direction of the closure assembly into the piston-rod-side region of the shock damper, and a movement in the bump direction is to be understood to mean a movement in the direction of the base valve into that region of the shock damper which is remote from the piston rod. The closure assembly is preferably arranged coaxially with respect to, and circumferentially surrounds, the piston rod.

The vibration damper comprises a rebound stop arrangement, which is designed to provide additional damping of the piston movement in the rebound stage. The rebound stop arrangement preferably comprises an auxiliary piston, a rebound stop chamber and a rebound stop receptacle. The rebound stop chamber is preferably formed within the first working chamber as an annular chamber between the piston rod and the rebound stop receptacle. The rebound stop receptacle is for example of sleeve-shaped, in particular cylindrical form, and preferably has a smaller diameter than the inner tube. The rebound stop receptacle preferably lies fluid-tightly against the inner wall of the damper tube. For example, the rebound stop receptacle is formed from a plastics material or a metal.

The auxiliary piston is fastened to the piston rod so as to be movable in the axial direction relative to the piston rod. The auxiliary piston is for example mounted in front of the working piston in the bump direction. The auxiliary piston is preferably arranged between the closure assembly and the working piston. The axial range of movement of the working piston within the damper tube is preferably set such that only the auxiliary piston, but not the working piston, is movable into the rebound stop chamber.

For example, the auxiliary piston comprises a plurality of, or exactly one, annular region(s) which are/is arranged coaxially with respect to the piston rod and are/is movable relative to the piston rod. The auxiliary piston is preferably dimensioned such that the auxiliary piston fluidically at least partially closes off the rebound stop chamber as the piston rod moves in the rebound direction, wherein the auxiliary piston preferably has a passage for allowing a flow to pass through the auxiliary piston.

In a first embodiment, one end of the spring element is mounted on the auxiliary piston, and the opposite, other end of said spring element is mounted, by means of a seat, so as to be positionally fixed relative to the piston rod, wherein the auxiliary piston is preferably arranged in the rebound direction relative to the seat. The seat is preferably arranged between the working piston and the base valve. The spring element is preferably designed as a spiral spring.

The spring element is preferably fixedly connected to the piston rod via the seat, such that that end of the spring element which points in the bump direction moves together with the piston rod, whilst that end of the spring element which points in the rebound direction is movable relative to the piston rod, and moves together with the auxiliary piston. This ensures that the spring element is activated, in particular compressed, as soon as the auxiliary piston has moved into the rebound stop receptacle.

In a further embodiment, the rebound stop arrangement has a sealing ring between the auxiliary piston and the piston rod, which sealing ring is arranged to provide a fluid-tight seal of the auxiliary piston against the piston rod. A fluid flow between the auxiliary piston and the piston rod is thus prevented. In particular, it is thus the case that hydraulic fluid exits the rebound stop chamber, in particular into the first working chamber, exclusively via a gap in the piston ring.

In a further embodiment, the sealing ring is mounted so as to be axially movable relative to the piston rod. The sealing ring is preferably mounted on the piston rod so as to be slidable relative thereto in the axial direction.

In a further embodiment, the sealing ring is mounted on the auxiliary piston so as to be positionally fixed relative thereto. For example, a gap is formed between the piston rod and the auxiliary piston, which gap preferably allows a relative movement. A movement of the sealing ring together with the auxiliary piston ensures reliable sealing of the gap.

In a further embodiment, the auxiliary piston has a first piston region and a second piston region, wherein the sealing ring bears fluid-tightly against the first and the second piston region. The sealing ring preferably lies against the radially inwardly pointing surfaces of each of the piston regions. Preferably, the auxiliary piston is formed in two parts and has a first piston region and a second piston region, which are each mounted so as to be movable relative to the piston rod. A two-part form allows the auxiliary piston to be easily installed on the piston rod. The piston regions are for example of annular form and preferably lie fluid-tightly against one another, or are connected to one another.

The sealing ring is preferably arranged circumferentially around, and coaxially with respect to, the piston rod. In particular, the sealing ring lies against the inner surface of the second piston region, preferably between the piston rod and the second piston region, and is, by way of example, radially spaced from the second piston region. The inner surface of the second piston region preferably has a radially inwardly directed projection which forms an axial abutment surface for the sealing ring for fluid-tight abutment of the sealing ring against the abutment surface of the second piston region. The sealing ring additionally lies in particular against the first piston region, preferably the end face of the first piston region. The sealing ring preferably lies fluid-tightly against the mounting region of the first piston region. In particular, the sealing ring lies fluid-tightly at least against the piston rod, the first piston region and the second piston region.

In a further embodiment, between the first and the second piston region, there is arranged a piston ring which is mounted so as to be axially movable relative to the first and the second piston region. The piston ring is preferably designed as a C-ring with an opening. The piston ring is in particular mounted movably in the axial direction.

In particular, the second piston region has a circumferential recess which is open in the direction of the first piston region. The piston ring is preferably arranged within the recess. The axial length of the piston ring is preferably smaller than the axial length of the recess, such that the piston ring is preferably mounted movably in the axial direction relative to the first and the second piston region. In particular, the movement of the piston ring is limited in the bump direction by the first piston region and in the rebound direction by the second piston region.

The outer diameter of the first and the outer diameter of the second piston region are preferably smaller than the inner diameter of the rebound stop receptacle, such that hydraulic fluid can be caused to flow between the first and the second piston region and the rebound stop receptacle. The piston ring preferably has an outer diameter which corresponds to the inner diameter of the rebound stop receptacle and forms a fluid-tight closure therewith. In particular, the piston ring has an inner diameter greater than the inner diameter of the recess in the second piston region, such that hydraulic fluid can be caused to flow between the piston ring and the first and/or second piston region. The auxiliary piston preferably has a bypass channel which is formed between the inner diameter of the piston ring and the first and/or second piston region and which extends in particular circumferentially, preferably over the entire circumference. The bypass channel forms a fluidic connection between the rebound stop chamber and the first working chamber arranged in the bump direction of the auxiliary piston.

The auxiliary piston is preferably formed such that the piston ring is movable from an opened position, in which the bypass channel is in particular completely opened, into a closed position, in which the flow diameter of the bypass channel has been reduced relative to the opened position, in particular has been at least partially or completely closed by the piston ring. Preferably, in the closed position, the bypass channel is formed exclusively by the opening of the piston ring formed as a C-ring.

In a further embodiment, the first and the second piston region are connected to one another by means of an interlocking, frictional and/or substance-to-substance bonded connection. In particular, the first and the second piston region are not movable relative to one another.

In a further embodiment, the first piston region has a mounting region for the mounting of the first piston region on the second piston region, wherein the mounting region has a plurality of at least partially radially inwardly pointing connecting projections which interact with cutouts in the second piston region so as to form an interlocking and/or frictional connection, in particular a snap-action connection.

The mounting region preferably forms that end of the first piston region which points in the direction of the second piston region. The connecting projections are in particular oriented in the direction of the piston rod at an angle of approximately 10 to 60°, preferably 20° to 40°, in particular 30°, with respect to the axial direction. The mounting region comprises, for example, a plurality of arms which extend in the axial direction and on each of which at least one connecting projection is formed. In particular, the second piston region has cutouts, in particular an annular groove, into which the connecting projections engage. The connecting projections preferably form a snap-action connection with the cutouts in the second piston region. In particular, the second piston region has an axial bearing surface which points in the direction of the spring element and against which the spring element lies. The bearing surface is, by way of example, of planar, flat form.

In a further embodiment, the rebound stop arrangement comprises a rebound stop chamber which is formed between the rebound stop receptacle, the auxiliary piston and the closure assembly, said rebound stop chamber being fluidically connected exclusively to the first working chamber. The rebound stop chamber is preferably delimited by the rebound stop receptacle, the auxiliary piston and the closure assembly. The rebound stop chamber is preferably hydraulically connected exclusively to the first working chamber, the piston-rod-side working chamber. The closure assembly closes off the rebound stop chamber preferably completely fluid-tightly, such that the hydraulic fluid can be caused to flow from the rebound stop chamber exclusively into the first working chamber, in particular exclusively past the auxiliary piston, preferably through the bypass channel.

In a further embodiment, the spring element is arranged at least partially within the rebound stop receptacle. In particular, the spring element is arranged within the rebound stop receptacle in the rebound stage of the vibration damper.

In a further embodiment, the auxiliary piston has a connecting region for connecting the auxiliary piston to the spring element, wherein the spring element is connected to the connecting region of the auxiliary piston fixedly, by means of an interlocking and/or frictional connection, in particular a press fit. The auxiliary piston preferably forms a seat for the spring element and thus allows reliable interaction of the spring element with the auxiliary piston. The spring element serves to provide additional damping of the auxiliary piston as the auxiliary piston moves in the rebound direction, such that an abutment of the auxiliary piston against the end region of the damper, in particular the closure assembly, is preferably prevented. The connecting region has, for example, a profiling. The profiling is preferably formed on the outer and/or the inner circumference of the connecting region. The profiling serves to provide a stronger connection, in particular a press-fit connection, between the connecting region of the auxiliary piston and the spring element. The profiling preferably comprises a plurality of projections on the inwardly pointing circumferential surface, wherein the projections are for example uniformly spaced from one another and extend in particular in the axial or radial direction.

The spring element is preferably a spiral spring, wherein the inner diameter of the spiral spring is smaller than the outer diameter of the connecting region of the auxiliary piston. The spring element is preferably pressed or clamped onto the connecting region of the auxiliary piston. In particular, at least one or two windings are fastened to the connecting region. In particular, that end of the spring element which is situated opposite the auxiliary piston is fastened to a seat that is mounted so as to be positionally fixed. For example, the closure assembly forms an axial stop for the abutment of the auxiliary piston as the piston rod moves in the rebound direction. The spring element is preferably fastened positionally fixedly to the seat. The seat is preferably arranged coaxially with respect to the piston rod, and is in particular fastened to the piston rod.

For example, the connecting region is adjoined in the direction of the first piston region by a region which has a greater diameter than the connecting region and which forms an axial bearing surface for the spring element. The spring element is preferably supported on the bearing surface as the auxiliary piston moves in the rebound direction. The bearing surface preferably points in the rebound direction and is in particular of planar, flat form.

For example, the second piston region of the auxiliary piston is formed from a plastics material. The second piston region is preferably manufactured by plastics injection moulding. Such a piston region is particularly inexpensive to manufacture. It is preferable for only the second piston region, which is arranged in the bump direction relative to the first piston region, to be formed from the plastics material. Lower loads act on said region of the auxiliary piston during the operation of the vibration damper, such that said region can be formed from a less expensive material, such as plastics material.

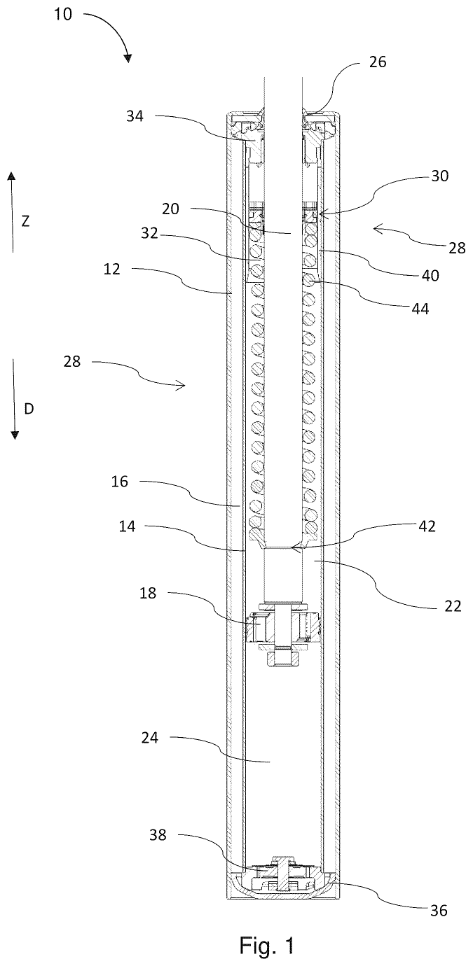

FIG. 1 shows a vibration damper 10, wherein the vibration damper 10 is, by way of example, a multi-tube vibration damper, for example a 2-tube vibration damper. The vibration damper 10 has an outer tube 12 that forms an outer surface, in particular a housing, of the vibration damper 10. Arranged within and coaxially with respect to the outer tube 12 is a damper tube 14, which is also referred to as inner tube 14. Formed between the outer tube 12 and the inner tube 14 is an equalizing chamber 16, which is preferably filled at least partially or completely with a hydraulic fluid. For example, the equalizing chamber 16 is partially filled with a gas.

A working piston 18, which is connected to the piston rod 20, is arranged within the inner tube 14 so as to be movable within the inner tube 14, wherein the inner tube 14 is preferably formed as a guide for the working piston 18. The working piston 18 preferably has a valve device. For example, the valve device comprises a rebound stage valve, for damping the piston movement in the rebound stage, and a bump stage valve, for damping the piston movement in the bump stage. The valves are preferably each formed by a passage opening through the piston and by a valve disc assembly. The working piston 18 divides the interior of the inner tube 14 into a first working chamber 22, which is arranged at the piston rod side, and a second working chamber 24, which is remote from the piston rod. The piston rod 20 is preferably connectable, by way of its end which projects out of the damper tube 14, to the vehicle body.

The interior of the outer tube 12 is fluidically sealed off at the piston rod side by means of a closure assembly 34. Opposite the closure assembly 34, at the end remote from the piston rod, the interior of the outer tube 12 is fluidically sealed off by means of a base piece 36. By way of example, a base valve 38 is arranged on the base piece 36, which base valve is mounted in particular on that end of the inner tube 14 which is remote from the piston rod. The base valve 38 is preferably a check valve through which flow can pass in both directions or only in one direction. The second working chamber 24 is preferably fluidically connected via the base valve 38 to the equalizing chamber 16. The piston-rod-side end of the inner tube 14 is preferably fastened to the closure assembly 34.

By way of example, the outer tube 12 is surrounded at the piston-rod-side end region by a cap or a seal 26. The cap or the seal 26 preferably forms an end piece of the outer tube 12 and a closure with respect to the piston rod 20.

The vibration damper 10 furthermore comprises a rebound stop arrangement 28 for providing additional damping of the piston movement in the rebound direction Z in the rebound stage. By way of example, the rebound stop arrangement 28 comprises an auxiliary piston 30, a rebound stop chamber 32 and a rebound stop receptacle 40. The auxiliary piston 30 is preferably mounted axially movably on the piston rod 20. In the rebound direction Z, the auxiliary piston 30 is mounted in front of the working piston 18, such that, as the piston rod 20 moves in the rebound direction Z, that is to say in the direction out of the damper tube 14, the auxiliary piston 30 reaches the rebound stop chamber 32 before the working piston 18. The axial range of movement of the working piston 18 within the damper tube 14 is preferably set such that only the auxiliary piston 30, but not the working piston 18, is movable into the rebound stop chamber 32. The rebound stop receptacle 40 is preferably mounted on that end region of the damper tube 14 which points in the rebound direction Z, and said rebound stop receptacle is, by way of example, connected to the closure assembly 34. The rebound stop chamber 32 is preferably formed between, and preferably delimited by, the rebound stop receptacle 40, the auxiliary piston 30 and the closure assembly 34. The rebound stop chamber 32 is preferably hydraulically connected exclusively to the first working chamber 22, the piston-rod-side working chamber 22. The closure assembly 34 closes off the rebound stop chamber 32 preferably completely fluid-tightly, such that the hydraulic fluid can be caused to flow from the rebound stop chamber 32 exclusively into the first working chamber 22, in particular exclusively past the auxiliary piston 30.

The rebound stop chamber 32 is formed as an annular chamber between the piston rod 20 and the rebound stop receptacle 40. The rebound stop receptacle 40 is for example of sleeve-shaped, in particular cylindrical form, and has a smaller diameter than the inner tube 14. The rebound stop receptacle 40 preferably lies fluid-tightly against the inner wall of the inner tube 14. For example, the rebound stop receptacle 40 is formed from a plastics material or a metal. By way of example, the rebound stop receptacle 40 has a constant inner diameter and/or outer diameter. The damper tube 14 has, in particular, a constant inner diameter and/or outer diameter.

The rebound stop arrangement 28 also comprises a spring element 44, in particular a spiral spring. The spring element 44 is arranged coaxially with respect to and around the piston rod 20. The spring element 44 preferably has an inner diameter equal to or greater than the outer diameter of the piston rod 20, and an outer diameter equal to or less than the inner diameter of the inner tube 14, in particular of the rebound stop receptacle 40. The spring element 44 is preferably mounted movably relative to the piston rod 20 in the axial direction along same. By way of example, one end of the spring element 44 is supported on the auxiliary piston 30, and the other end of said spring element is supported on a seat 42. The seat 42 is, by way of example, connected fixedly to the spring element 44 and is preferably arranged coaxially with respect to the piston rod 20. In particular, the seat 42 is fastened positionally fixedly to the piston rod 20.

The closure assembly 34 forms, by way of example, an upper stop for the movement of the spring element 44 and of the auxiliary piston 30 in the rebound direction Z. The seat 42 preferably lies positionally fixedly against the piston rod 20 during a movement of said piston rod in the rebound direction Z. The seat 42 preferably has an outer diameter smaller than the inner diameter of the inner tube 14, such that hydraulic fluid can be caused to flow between the inner tube and the seat 42. The outer diameter of the seat 42 is preferably so small that said seat generates negligible resistance to flow during a piston movement.

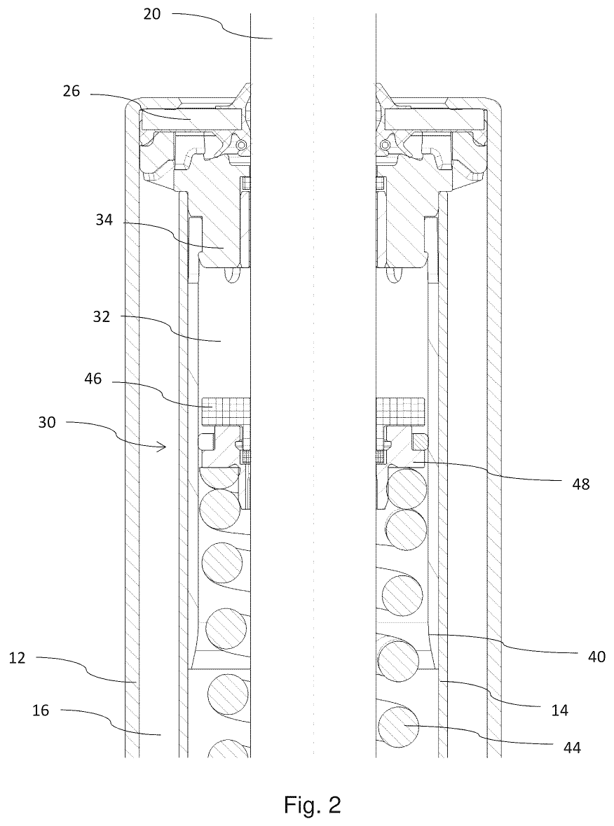

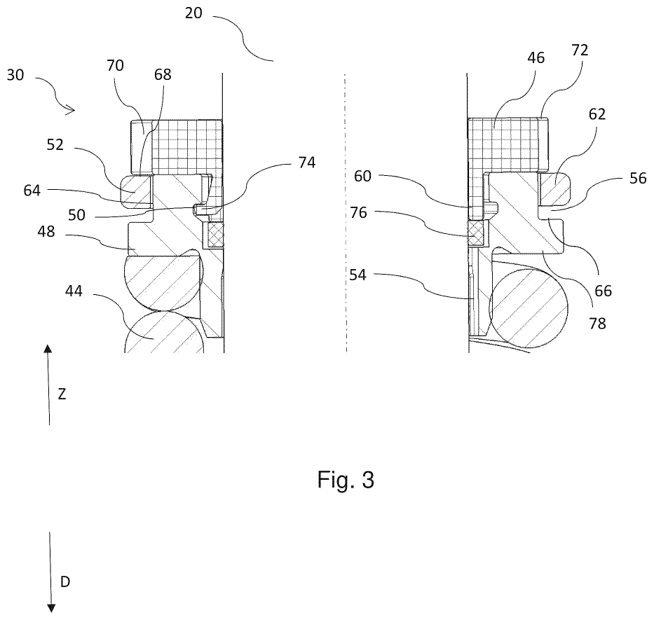

FIG. 2 and FIG. 3 each show the auxiliary piston 30 in a more detailed illustration. The auxiliary piston 30 has a first, in particular annular, piston region 46 which is mounted axially movably on the piston rod 20, such that the piston region 46 is movable relative to the piston rod 20 and in particular slides along the piston rod 20 in the axial direction.

The first piston region 46 preferably forms that end of the auxiliary piston 30 which points in the direction of the closure assembly 34. In the bump direction D, the first piston region 46 is adjoined by a second piston region 48. The piston regions 46, 48 are arranged coaxially with respect to, and preferably mounted axially movably relative to, the piston rod 20. By way of example, the second piston region 48 lies with at least one surface against the first piston region 46. In particular, the first and the second piston region 46, 48 each have axial abutment surfaces at which they abut against one another. The second piston region 48 is preferably connected interlockingly, by substance-to-substance bonding and/or frictionally to the first piston region. For example, the first piston region 46 is connected to the second piston region 48 by way of a press fit or a clamping connection. The first piston region 46 preferably has an annular groove 50 that forms a press fit with the, preferably lower, end region of the first piston region 46. The second piston region 48 preferably has an inner diameter greater than the outer diameter of the piston rod 20, such that the second piston region 48 is movable relative to the piston rod 20. A piston ring 52 is arranged between the first and the second piston region 46, 48. The piston ring 52 is for example formed as a C-ring with an opening 62.

The first piston region 46 has, by way of example, a region with an outer diameter which protrudes in the radial direction beyond the second piston region 48 and which preferably forms an axial bearing surface for the piston ring 52. The outer diameter of the first and of the second piston region 46, 48 and of the piston ring 52 is preferably smaller, at every point, than the inner diameter of the inner tube 14, such that a fluid passage is formed between the inner tube 14 and both the first and second piston region 46, 48 and the piston ring 52.

In particular, the second piston region 48 forms that end of the auxiliary piston 30 which points in the direction of the base valve 38. By way of example, the second piston region 48 has, at the base-valve-side end, a connecting region 54 for connecting the second piston region 48 to the spring element 44. In particular, the connecting region 54 has a smaller diameter than the rest of the second piston region 48. The connecting region 54 preferably has an outer diameter that corresponds to or is greater than the inner diameter of the spring element 44. The spring element 44 is preferably connected by means of an interlocking and/or frictional connection to the connecting region 54 of the second piston region 48. In particular, the spring element 44 is pressed onto the connecting region 54 of the second piston region 48. The spring element 44 is preferably pressed onto the connecting region 54 by way of a press fit of at least one, two or more lower spring windings. The connecting region 54 preferably has a substantially constant outer diameter. The connecting region 54 is adjoined in the direction of the first piston region 46 by a region which has a greater diameter than the connecting region and which forms an axial bearing surface for the spring element 44. In particular, the second piston region 48 has a circumferential recess 56 which is open in the direction of the first piston region 46. The piston ring 52 is preferably arranged within the recess 56. The axial length of the piston ring 52 is preferably smaller than the axial length of the recess 56, such that the piston ring is preferably mounted movably in the axial direction relative to the first and the second piston region 46, 48. The first and the second piston region 46, 48 are preferably not movable relative to one another. The movement of the piston ring 52 is preferably limited in the bump direction D by the first piston region 46 and in the rebound direction Z by the second piston region 48. A movement of the piston rod 20 in the bump direction D preferably leads to a movement of the auxiliary piston 30 in the bump direction D together with the piston rod 20. As the piston rod 20 moves in the rebound direction Z, the auxiliary piston 30 is also moved in the rebound direction Z and, beyond a particular deflection in the Z direction, enters the rebound stop receptacle 40. The piston rod 52 preferably has an outer diameter which corresponds to the inner diameter of the rebound stop receptacle 40, such that the auxiliary piston 30 bears at least partially or completely fluid-tightly against the rebound stop receptacle 40. The movement of the auxiliary piston 30 is dampened after it enters the rebound stop receptacle 40, such that said auxiliary piston moves more slowly relative to the piston rod 20 in the rebound direction Z, and the spring element 44 is preferably compressed.

The auxiliary piston 30 is preferably dimensioned such that, as the piston rod 20 moves in the rebound direction Z, the auxiliary piston 30 fluidically closes off the rebound stop chamber 32. By way of example, the damper tube 14 has a constant inner diameter, against which the rebound stop receptacle 40 lies in the piston-rod-side end region. By way of example, the rebound stop receptacle 40 has an end region remote from the piston rod and has a piston-rod-side end region, wherein the end region which is remote from the piston rod, and which faces toward the base valve 38, has for example a conically tapering inlet region, such that the outer diameter of the rebound stop chamber 32 increases, preferably continuously, from the inner diameter of the damper tube 14 to the first inner diameter of the rebound stop receptacle 40. The conical inlet region of the rebound stop receptacle 40 is preferably adjoined by a region having a constant inner diameter.

The rebound stop receptacle 40 preferably lies, by way of the end face of the closure-assembly-side end region, against the closure assembly 34, and preferably forms a fluid-tight seal. In particular, the rebound stop receptacle 40 and the closure assembly 34 are fixedly connected to one another, in particular in interlocking, substance-to-substance bonded and/or frictional fashion.

The rebound stop receptacle 40 furthermore has, by way of example, a plurality of axially extending radial protrusions which preferably extend in the axial direction from the inlet region over approximately 40% to 60% of the length of the rebound stop receptacle 40. The protrusions are preferably formed such that the area thereof decreases in the rebound direction. In the context of this description, the inner diameter of the rebound stop receptacle 40 is to be understood in each case to mean the inner diameter of the rebound stop receptacle 40 without taking into consideration the protrusions.

The first and the second piston region 46, 48 are preferably formed such that the outer diameter is in each case smaller than the inner diameter of the rebound stop receptacle 40, such that hydraulic fluid can be caused to flow between the first and the second piston region 46, 48 and the rebound stop receptacle. The piston ring 52 preferably has an outer diameter which corresponds to the inner diameter of the rebound stop receptacle 40 and forms a fluid-tight closure therewith. In particular, the piston ring 52 has an inner diameter greater than the inner diameter of the recess 56 in the second piston region 48, such that hydraulic fluid can be caused to flow between the piston ring 52 and the first and/or second piston region 46, 48. The auxiliary piston 30 preferably has a bypass channel 64 which is formed between the inner diameter of the piston ring 52 and the first and/or second piston region 46, 48 and which extends in particular circumferentially, preferably over the entire circumference. The bypass channel 64 forms a fluidic connection between the rebound stop chamber 32 and the first working chamber 22 arranged in the bump direction of the auxiliary piston 30.

The auxiliary piston 30 is preferably formed such that the piston ring 52 is movable from an opened position, in which the bypass channel 64 is in particular completely opened, into a closed position, in which the flow diameter of the bypass channel 64 has been reduced relative to the opened position, in particular has been at least partially or completely closed by the piston ring 52. Preferably, in the closed position, the bypass channel 64 is formed exclusively by the opening 62 of the piston ring 52 formed as a C-ring.

The second piston region 48 has an axial abutment surface 66 for the abutment of the piston ring 52 in the closed position. The abutment surface 66 is preferably designed such that it forms a fluid-tight closure with the piston ring 52, in particular over the entire circumference of the piston ring 52. For example, the abutment surface 66 is formed as a planar, flat surface, or has a profiling which corresponds to a profiling of the piston ring 52 such that a fluid-tight connection is formed.

The first piston region 46 has an axial abutment surface 68 for the abutment of the piston ring 52 in the opened position. The abutment surface 68 is preferably formed such that, when the piston ring 52 abuts against the abutment surface 68, a hydraulic fluid can be caused to flow through the bypass channel 64, in particular between the abutment surface 68 and the piston ring 52. The abutment surface 68 preferably has a profiling, in particular a plurality of notches 70 and projections 72. The notches 70 are formed for example on the outer circumference of the first piston region 46, and form an axial flow passage from the piston-rod-side working chamber 22 into the rebound stop chamber 32.

The auxiliary piston 30 is preferably formed such that, when the auxiliary piston moves in the rebound direction Z, the piston ring 52 lies fluid-tightly against the second piston region 48, in particular the axial abutment surface 66. As the auxiliary piston 30 moves within the rebound stop receptacle 40, the piston ring 52 additionally lies fluid-tightly against the inner wall of the rebound stop receptacle 40, such that a hydraulic fluid can be caused to flow exclusively through the opening 62 in the piston ring 52 formed as a C-ring. The auxiliary piston 30 is preferably formed such that, as the auxiliary piston moves within the rebound stop receptacle 40 in the bump direction D, the piston ring 52 lies against the first piston region 46, in particular the axial abutment surface 68, and hydraulic fluid can be caused to flow between the profiling of the abutment surface 68 and the piston ring 52 and through the bypass channel 64.

By way of example, the first piston region 46 has a mounting region 60 for the mounting of the first piston region 46 on the second piston region 48. The mounting region 60 preferably forms that end of the first piston region 46 which points in the direction of the second piston region 48. In particular, the mounting region 60 has a plurality of at least partially radially inwardly oriented connecting projections 74 which are oriented in the direction of the piston rod 20 for example at an angle of approximately 10 to 60°, preferably 20° to 40°, in particular 30°, with respect to the axial direction. By way of example, the second piston region 48 has cutouts 50, in particular an annular groove, into which the connecting projections 74 engage. The connecting projections 74 preferably form a snap-action connection with the cutouts in the second piston region 48. By way of example, the mounting region 60 has a profiling, wherein a plurality of projections are provided on the outwardly pointing circumferential surface, which projections are for example uniformly spaced from one another and extend in particular in the axial direction. The second piston region 48 furthermore has an axial bearing surface 78 which points in the direction of the spring element 44 and against which the spring element 44 lies. The bearing surface 78 is, by way of example, of planar, flat form.

By way of example, the rebound stop arrangement 28 has a sealing ring 76 which is arranged circumferentially around, and coaxially with respect to, the piston rod 20. The sealing ring 76 preferably lies against the piston rod 20 so as to be slidable in the axial direction. In particular, the sealing ring 76 is arranged between the auxiliary piston 30 and the piston rod 20. By way of example, the sealing ring 76 is arranged between the first piston region 46 and the second piston region 48. In particular, the sealing ring 76 lies against the inner surface of the second piston region 48, preferably between the piston rod 20 and the second piston region 48, and is, by way of example, radially spaced from the second piston region 48. The inner surface of the second piston region 48 preferably has a radially inwardly directed projection which forms an axial abutment surface for the sealing ring 76 for fluid-tight abutment of the sealing ring 76 against the abutment surface of the second piston region 48. The sealing ring 76 additionally lies in particular against the first piston region 46, preferably the end face of the first piston region 46. The sealing ring 76 preferably lies fluid-tightly against the mounting region 60 of the first piston region 46. In particular, the sealing ring lies fluid-tightly at least against the piston rod 20, the first piston region 46 and the second piston region 48.

### LIST OF REFERENCE DESIGNATIONS

10 Vibration damper
12 Outer tube
14 Damper tube/inner tube
16 Equalizing chamber
18 Working piston
20 Piston rod
22 First working chamber
24 Second working chamber
26 Seal
28 Rebound stop arrangement
30 Auxiliary piston
32 Rebound stop chamber
34 Closure assembly
36 Base piece
38 Base valve
40 Rebound stop receptacle
42 Seat
44 Spring element
46 First piston region
48 Second piston region
50 Groove
52 Piston ring
54 Connecting region
56 Recess
60 Mounting region
62 Opening
64 Bypass channel
66 Axial abutment surface of the first piston region
68 Axial abutment surface of the second piston region
70 Notch
72 Projection
74 Connecting projections
76 Sealing ring
78 Bearing surface
Z Rebound direction
D Bump direction

1. A vibration damper for a vehicle, comprising:
a damper tube filled with hydraulic fluid,
a working piston which is connected to a piston rod and which is arranged within the damper tube so as to be movable back and forth, wherein an interior of the damper tube is divided by the working piston into a first working chamber and a second working chamber, and
a rebound stop arrangement having:
an auxiliary piston, which concentrically surrounds the piston rod, and
a sleeve-like rebound stop receptacle, which is mounted on the damper tube, for receiving the auxiliary piston in the rebound stage,
wherein the auxiliary piston is mounted on the piston rod so as to be axially movable relative thereto,
wherein the rebound stop arrangement has a spring element that is fastened to the auxiliary piston.

2. The vibration damper according to claim 1, wherein one end of the spring element is mounted on the auxiliary piston, and the other end of the spring element is mounted, by a seat, so as to be positionally fixed relative to the piston rod.

3. The vibration damper according to claim 1, wherein the rebound stop arrangement comprises a sealing ring between the auxiliary piston and the piston rod, which sealing ring is arranged to provide a fluid-tight seal of the auxiliary piston against the piston rod.

4. The vibration damper according to claim 3, wherein the sealing ring is mounted so as to be axially movable relative to the piston rod.

5. The vibration damper according to claim 3, wherein the sealing ring is mounted on the auxiliary piston so as to be positionally fixed relative thereto.

6. The vibration damper according to claim 3, wherein the auxiliary piston has a first piston region and a second piston region, and wherein the sealing ring bears fluid-tightly against the first and the second piston region.

7. The vibration damper according to claim 6, wherein the first and the second piston region are connected to one another by an interlocking, frictional and/or substance-to-substance bonded connection.

8. The vibration damper according to claim 6, wherein the first piston region has a mounting region for the mounting of the first piston region on the second piston region, and wherein the mounting region has a plurality of at least partially radially inwardly pointing connecting projections which interact with cutouts in the second piston region so as to form an interlocking and/or frictional connection.

9. The vibration damper according to claim 6, wherein the first piston region has a mounting region for the mounting of the first piston region on the second piston region, and wherein the mounting region has a plurality of at least partially radially inwardly pointing connecting projections which interact with cutouts in the second piston region so as to form a snap-action connection.

10. The vibration damper according to claim 1, wherein the auxiliary piston has a first piston region and a second piston region, and wherein, between the first and the second piston region, there is arranged a piston ring which is mounted so as to be axially movable relative to the first and the second piston region.

11. The vibration damper according to claim 10, wherein the first and the second piston region are connected to one another by an interlocking, frictional and/or substance-to-substance bonded connection.

12. The vibration damper according to claim 10, wherein the first piston region has a mounting region for the mounting of the first piston region on the second piston region, and wherein the mounting region has a plurality of at least partially radially inwardly pointing connecting projections which interact with cutouts in the second piston region so as to form an interlocking and/or frictional connection.

13. The vibration damper according to claim 10, wherein the first piston region has a mounting region for the mounting of the first piston region on the second piston region, and wherein the mounting region has a plurality of at least partially radially inwardly pointing connecting projections which interact with cutouts in the second piston region so as to form a snap-action connection.

14. The vibration damper according to claim 1, wherein the rebound stop arrangement comprises a rebound stop chamber which is formed between the rebound stop receptacle, the auxiliary piston and a closure assembly which fluid-tightly closes off the damper tube at the piston rod side, said rebound stop chamber being fluidically connected exclusively to the first working chamber.

15. The vibration damper according to claim 1, wherein the spring element is arranged at least partially within the rebound stop receptacle.

16. The vibration damper according to claim 1, wherein the auxiliary piston has a connecting region for connecting the auxiliary piston to the spring element, and wherein the spring element is connected to the connecting region of the auxiliary piston fixedly, by an interlocking and/or frictional connection.

17. The vibration damper according to claim 1, wherein the auxiliary piston has a connecting region for connecting the auxiliary piston to the spring element, and wherein the spring element is connected to the connecting region of the auxiliary piston fixedly, by a press fit.
